(19) United States
(12) Patent Application Publication
(10) Pub. No.: US 2023/0112801 A1
(43) Pub. Date: Apr. 13, 2023

(54) SYSTEMS AND METHODS FOR PREDICTING CHARGING EVENTS AND PREPARING ELECTRIFIED VEHICLES FOR CHARGING

(71) Applicant: FORD GLOBAL TECHNOLOGIES, LLC, Dearborn, MI (US)

(72) Inventors: George Hart VRAMPAS, Dearborn, MI (US); Ryan HUNT, Royal Oak, MI (US); Charles Everett BADGER, II, Westland, MI (US)

(21) Appl. No.: 17/500,330

(22) Filed: Oct. 13, 2021

(51) Int. Cl. B60L 53/60; B60L 53/16; B60L 53/35; B60L 58/12; H02J 7/00

(52) U.S. Cl. CPC B60L 53/60; B60L 53/16; B60L 53/35; B60L 58/12; H02J 7/0048

(57) ABSTRACT

Systems and methods may predict vehicle charging events and prepare electrified vehicles for charging. Learned charging habits such as typical charging locations, charging times, and battery level when charging occurs may be leveraged for predicting when a user is likely to charge their electrified vehicle. A contactor system of the electrified vehicle may be controlled to maintain a set of contactors of the contactor system in a closed position upon vehicle shutdown in response to predicting that the charging event is likely. Maintaining the set of contactors closed when charging events are expected reduces contactor wear and decreases noise, vibration, and harshness, thereby facilitating a more satisfying user charging experience.

### TECHNICAL FIELD

This disclosure relates to vehicle systems and methods for predicting charging events and preparing the vehicle for charging in a manner that improves the overall charging experience.

### BACKGROUND

Electrified vehicles are selectively driven by one or more traction battery pack powered electric machines. The electric machines can propel the electrified vehicles instead of, or in combination with, an internal combustion engine. Some electrified vehicles, such as plug-in hybrid electric vehicles (PHEVs) and battery electric vehicles (BEVs), include a charge port that is connectable to electric vehicle supply equipment (EVSE) for charging the traction battery pack.

A contactor system electrically couples the traction battery pack to various components of a vehicle high voltage bus. One or more contactors of the contactor system may isolate the traction battery pack from the components when opened and may operably connect the traction battery pack to the components when closed. The contactors typically automatically open at vehicle shutdown, thus requiring the contactors to close again when a charging event is commenced.

### SUMMARY

A vehicle charging system according to an exemplary aspect of the present disclosure includes, among other things, a contactor system including at least one contactor, and a control module programmed to command the at least one contactor to remain in a closed position at a vehicle shutdown when a charging event is predicted as being likely to occur subsequent to the vehicle shutdown.

In a further non-limiting embodiment of the foregoing vehicle charging system, the at least one contactor is maintained in the closed position for a threshold amount of time following the vehicle shutdown.

In a further non-limiting embodiment of either of the foregoing vehicle charging systems, the threshold amount of time is at least two minutes.

In a further non-limiting embodiment of any of the foregoing vehicle charging systems, in the closed position, the at least one contactor operably connects a traction battery pack to a charge port assembly of the vehicle charging system.

In a further non-limiting embodiment of any of the foregoing vehicle charging systems, the control module is further programmed to command a charge port assembly to perform a function when the charging event is predicted as being likely to occur subsequent to the vehicle shutdown.

In a further non-limiting embodiment of any of the foregoing vehicle charging systems, the function includes opening a charge port door of the charge port assembly.

In a further non-limiting embodiment of any of the foregoing vehicle charging systems, the function includes illuminating a charge port lighting module of the charge port assembly.

In a further non-limiting embodiment of any of the foregoing vehicle charging systems, the control module is programmed to predict that the charging event is likely to occur based on learned charging habits of a user of the vehicle charging system.

In a further non-limiting embodiment of any of the foregoing vehicle charging systems, the learned charging habits are inferred based on charging location data.

In a further non-limiting embodiment of any of the foregoing vehicle charging systems, the learned charging habits are inferred based on charging time data.

In a further non-limiting embodiment of any of the foregoing vehicle charging systems, the learned charging habits are inferred based on battery charge level data.

In a further non-limiting embodiment of any of the foregoing vehicle charging systems, the control module is programmed to infer the vehicle shutdown based on an ignition-off condition.

A method according to another exemplary aspect of the present disclosure includes, among other things, predicting, via a control module of a vehicle charging system, when a charging event is likely to occur, and commanding a contactor of the vehicle charging system to remain closed at a vehicle shutdown in response to the predicting.

In a further non-limiting embodiment of the foregoing method, the predicting includes monitoring a learned charging habit of a user of the vehicle charging system.

In a further non-limiting embodiment of either of the foregoing methods, the monitoring includes monitoring charging location data, charging time data, and/or battery charge level data.

In a further non-limiting embodiment of any of the foregoing methods, the method includes commanding a charge port door of a charge port assembly of the vehicle charging system to move to an open position in response to the predicting.

In a further non-limiting embodiment of any of the foregoing methods, the method includes commanding a charge port lighting module of a charge port assembly of the vehicle charging system to illuminate in response to the predicting.

In a further non-limiting embodiment of any of the foregoing methods, the commanding includes commanding the contactor to remain closed for a threshold amount of time following the vehicle shutdown.

In a further non-limiting embodiment of any of the foregoing methods, the threshold amount of time is at least two minutes.

In a further non-limiting embodiment of any of the foregoing methods, the contactor operably connects a traction battery pack to a charge port assembly of the vehicle charging system when closed.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates an electrified vehicle operably connected to an electric vehicle supply equipment (EVSE) system during a charging event.

FIG. 2 schematically illustrates an exemplary charging system of the electrified vehicle of FIG. 1.

FIG. 3 illustrates an exemplary charge port assembly of the electrified vehicle of FIG. 1.

FIG. 4 is a flow chart of an exemplary vehicle method for predicting and preparing for charging events.

### DETAILED DESCRIPTION

This disclosure describes systems and methods for predicting and preparing for electrified vehicle charging events. Learned charging habits such as typical charging locations, charging times, and battery level when charging occurs may be leveraged for predicting when a user is likely to charge their electrified vehicle. A contactor system of the electrified vehicle may be controlled to maintain a set of contactors of the contactor system in a closed position upon vehicle shutdown in response to predicting the charging event. Maintaining the contactors closed when charging events are expected reduces contactor wear and decreases noise, vibration, and harshness, thereby facilitating a more satisfying user charging experience. These and other features of this disclosure are discussed in greater detail in the following paragraphs of this detailed description.

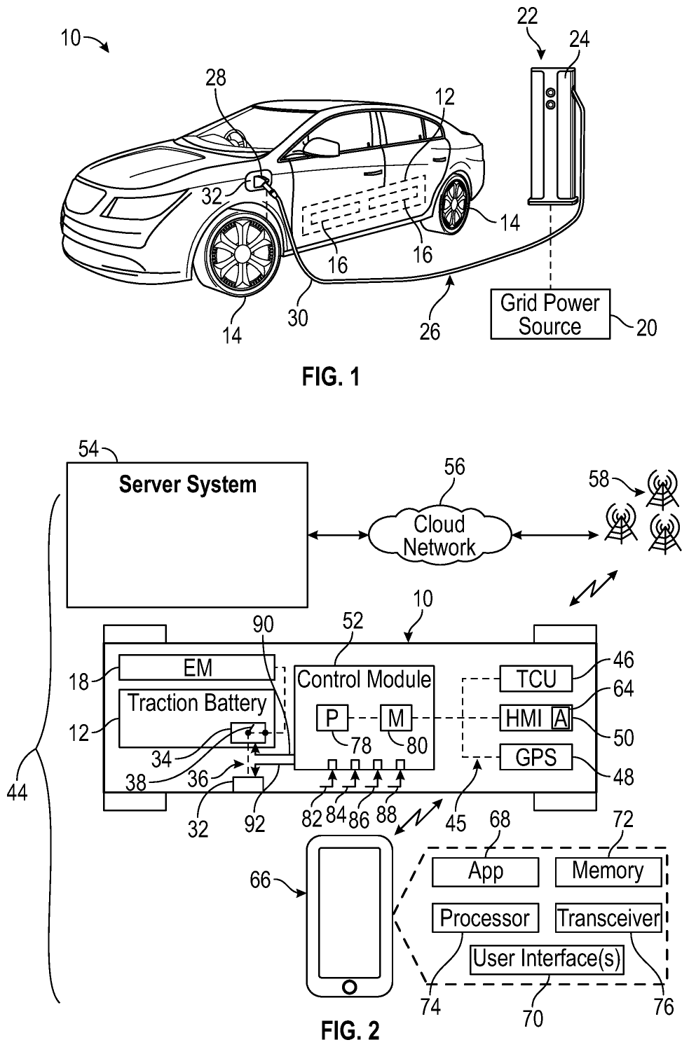

FIG. 1 illustrates an exemplary electrified vehicle 10 that includes a traction battery pack 12. The electrified vehicle 10 may include any electrified powertrain capable of applying a torque from an electric machine for providing motive power for driving drive wheels 14 of the electrified vehicle 10. In an embodiment, the electrified vehicle 10 is a plug-in hybrid electric vehicle (PHEV). In another embodiment, the electrified vehicle is a battery electric vehicle (BEV). Therefore, the powertrain of the electrified vehicle 10 may electrically propel the drive wheels 14 either with or without the assistance of an internal combustion engine.

The electrified vehicle 10 of FIG. 1 is schematically illustrated as a car. However, the teachings of this disclosure may be applicable to any type of vehicle, including but not limited to, cars, trucks, vans, sport utility vehicles (SUVs), etc.

Although shown schematically, the traction battery pack 12 may be a high voltage traction battery pack that includes a plurality of battery arrays 16 (e.g., battery assemblies or groupings of battery cells) capable of outputting electrical power to one or more electric machines (e.g., electric motors) of the electrified vehicle 10. Other types of energy storage devices and/or output devices can also be used to electrically power the electrified vehicle 10.

The traction battery pack 12 may periodically require charging for replenishing its energy levels. The electrified vehicle 10 may therefore interface with a grid power source 20 (e.g., AC power, solar power, wind power, or combinations thereof) through an electric vehicle supply equipment (EVSE) system 22 in order to transfer energy from the grid power source 20 to the electrified vehicle 10 for charging the traction battery pack 12.

The EVSE system 22 may include an EVSE housing 24 and a charging cord assembly 26. The EVSE housing 24 may be configured as a wall box, a charging station stanchion, etc. The specific configuration of the EVSE housing 24 is not intended to limit this disclosure. The EVSE housing 24 may include the necessary equipment (e.g., relays, human machine interfaces, etc.) for coordinating the transfer of energy between the grid power source 20 and the electrified vehicle 10.

The charging cord assembly 26 may include a charge coupler 28 and a cable 30. The cable 30 may be connected at one end to the charge coupler 28 and at an opposite end to the EVSE housing 24. The charge coupler 28 may be coupled (e.g., plugged-in) to a charge port assembly 32 (sometimes referred to as a vehicle inlet assembly) of the electrified vehicle 10 in order to transfer energy between the grid power source 20 and the electrified vehicle 10. In some embodiments, the charging cord assembly 26 could include a second charge coupler that is configured to be coupled to a socket of the EVSE housing 24.

In an embodiment, the charge coupler 28 is configured to plug into an SAE J1772 type charge port assembly. However, other charge coupler configurations are further contemplated within the scope of this disclosure. The specific configurations of the charge coupler 28 and the charge port assembly 32 are therefore not intended to limit this disclosure. The EVSE system 22 may be further configured to provide any level of charging (e.g., Level 1 AC charging, Level 2 AC charging, DC charging, etc.) within the scope of this disclosure.

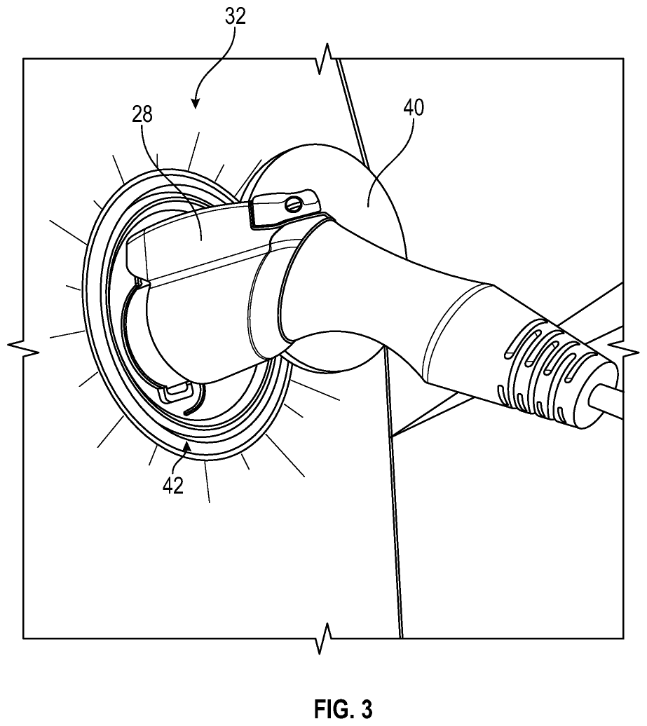

FIG. 2, with continued reference to FIG. 1, is a highly schematic depiction of a vehicle charging system 44 of the electrified vehicle 10. As is further detailed below, the vehicle charging system 44 may be configured to both predict when a charging event is likely to occur and prepare the electrified vehicle 10 for charging upon a vehicle shutdown when the charging event is predicted as being likely.

The vehicle charging system 44 may include a contactor system 34 adapted to selectively isolate/couple the traction battery pack 12 from/to other components that are part of a high voltage bus 36 of the electrified vehicle 10. The contactor system 34 may include one or more sets of contactors 38 that may be controlled to open and close the high voltage power lines that connect between the various components located on the high voltage bus 36. For example, the contactors 38 of the contactor system 34 may be moved to closed positions (shown in phantom lines) to operably connect the traction battery pack 12 to an electric machine 18 (e.g., an electric motor) for powering the electric machine 18 to achieve electric propulsion and/or to operably connect the traction battery pack 12 to the charge port assembly 32 for allowing charging power to be transferred to the traction battery pack 12 from the grid power source 20. Alternatively, the contactors 38 of the contactor system 34 may be moved to open positions to decouple the traction battery pack 12 from the components of the high voltage bus 36. The same or a different set of contactors 38 may be provided for operably coupling the traction battery pack 12 to the electric machine 18 and the charge port assembly 32, respectively.

The contactor system 34 may be a component of the traction battery pack 12. In an embodiment, the contactor system 34 is part of a bussed electrical center (BEC) of the traction battery pack 12. However, the contactor system 34 could be packaged elsewhere within the traction battery pack 12 or could alternatively be packaged separately from the traction battery pack 12 within the scope of this disclosure.

As further part of the vehicle charging system 44, the electrified vehicle 10 may include a telecommunications module 46, a global positioning system (GPS) 48, a human machine interface (HMI) 50, and a control module 52. These and other components may be interconnected and in electronic communication with one another over a communication bus 45 of the electrified vehicle 10. The communication bus 45 may be a wired communication bus such as a controller area network (CAN) bus, or a wireless communication bus such as Wi-Fi, Bluetooth®, Ultra-Wide Band (UWB), etc.

The telecommunications module 46 may be configured for achieving bidirectional communications with a cloud-based server system 54. The telecommunications module 46 may communicate over a cloud network 56 (e.g., the internet) to obtain various information stored on the server system 54 or to provide information to the server system 54 that can subsequently be accessed by the electrified vehicle 10. The server system 54 can identify, collect, and store user data associated with the electrified vehicle 10 for validation purposes. Upon an authorized request, data may be subsequently transmitted to the telecommunications module 46 via one or more cellular towers 58 or some other known communication technique (e.g., Wi-Fi, Bluetooth®, data connectivity, etc.). The telecommunications module 46 can receive data from the server system 54 or can communicate data back to the server system 54 via the cellular tower(s) 58. Although not necessarily shown or described in this highly schematic embodiment, numerous other components may enable bidirectional communications between the electrified vehicle 10 and the server system 54.

In a first embodiment, a user/owner of the electrified vehicle 10 may interface with the server system 54 using the HMI 50. For example, the HMI 50 may be equipped with an application 64 (e.g., FordPass™ or another similar web-based application) for allowing users to interface with the server system 54. The HMI 50 may be located within a passenger cabin of the electrified vehicle 10 and may include various user interfaces for displaying information to the vehicle occupants and for allowing the vehicle occupants to enter information into the HMI 50. The vehicle occupants may interact with the user interfaces presentable on the HMI 50 via touch screens, tactile buttons, audible speech, speech synthesis, etc.

In another embodiment, the user/owner of the electrified vehicle 10 may alternatively or additionally interface with the server system 54 for coordinating functions of the vehicle charging system 44 using a personal electronic device 66 (e.g., a smart phone, tablet, computer, wearable smart device, etc.). The personal electronic device 66 may include an application 68 (e.g., FordPass™ or another similar application) that includes programming to allow the user to employ one or more user interfaces 70 for setting or controlling certain aspects of the vehicle charging system 44. The application 68 may be stored in a memory 72 of the personal electronic device 66 and may be executed by a processor 74 of the personal electronic device 66. The personal electronic device 66 may additionally include a transceiver 76 that is configured to communicate with the server system 54 over the cellular tower(s) 58 or some other wireless link.

The GPS 48 is configured to pinpoint locational coordinates of the electrified vehicle 10. The GPS 48 may utilize geopositioning techniques or any other satellite navigation techniques for estimating the geographic position of the electrified vehicle 10 at any point in time. GPS data from the GPS 48 may be used to infer learned charging habits of the user of the electrified vehicle 10, as is further detailed below.

The control module 52 may include both hardware and software and could be part of an overall vehicle control system, such as a vehicle system controller (VSC), or could alternatively be a stand-alone controller separate from the VSC. In an embodiment, the control module 52 is programmed with executable instructions for interfacing with and commanding operation of various components of the vehicle charging system 44. Although shown as separate modules within the highly schematic depiction of FIG. 2, the telecommunications module 46, the GPS 48, the HMI 50, and the control module 52 could be integrated together as part of common module of the electrified vehicle 10.

The control module 52 may include a processor 78 and non-transitory memory 80 for executing various control strategies and modes associated with the vehicle charging system 44. The processor 78 may be a custom made or commercially available processor, a central processing unit (CPU), or generally any device for executing software instructions. The memory 80 may include any one or combination of volatile memory elements and/or nonvolatile memory elements.

The processor 78 may be operably coupled to the memory 80 and may be configured to execute one or more programs stored in the memory 80 of the control module 52 based on the various inputs received from other devices, such as the server system 54, the telecommunications module 46, the GPS 48, the HMI 50, the traction battery pack 12, etc. In an embodiment, the application 64 (e.g., FordPass™ or another similar application), which includes programming for allowing the vehicle user to employ one or more user interfaces within the HMI 50 for setting or controlling certain aspects of the vehicle charging system 44, may be stored in the memory 80 and may be executed by the processor 78 of the control module 52. Alternatively or additionally, the control module 52 may be configured to communicate and interface with the personal electronic device 66 for coordinating and/or executing certain aspects of the vehicle charging system 44 through the application 68.

The control module 52 may receive and process various inputs for predicting when a charging event is likely to occur and for preparing the electrified vehicle 10 for charging when the charging event is predicted as being likely. In this disclosure, the term “charging event” indicates a plug-in event in which the charge coupler 28 of the charge cord assembly 26 is plugged into the charge port assembly 32 such that energy can be transferred from the grid power source 20 to the traction battery pack 12.

In an embodiment, based at least on inputs from the GPS 48 and/or the server system 54, the control module 52 may predict when an upcoming charging event is likely to occur. The control module 52 may be programmed to predict when the charging event is likely to occur by assessing learned charging habits of the user of the electrified vehicle 10. The learned charging habits may be inferred or learned values that are based on historical charging-related data associated with the electrified vehicle 10. The charging-related data associated with the learned charging habits may be monitored and then recorded within the GPS 48, the server system 54, and/or the memory 80 of the control module 52 each time a charging event of the electrified vehicle 10 occurs.

In an embodiment, the control module 52 may employ a learning tool such as a probabilistic model or neural network for inferring when future charging events are likely to occur based on the learned charging habits. In another embodiment, the server system 54 may employ a cloud based computing tool for inferring when the future charging events are likely to occur based on the learned charging habits. However, the specific methodology used to predict the charging events is not intended to limit this disclosure.

In an embodiment, the learned charging habits of the user may be based on charging location data 82 that may be received as an input to the control module 52. The charging location data 82 may include locations where the user typically plugs-in to charge the electrified vehicle 10. For example, the user may typically charge at home, at work, and/or at other location(s), and these typical charging locations can be learned and recorded for helping predict future charging events.

In another embodiment, the learned charging habits of the user may be based on charging time data 84 that may be received as another input to the control module 52. The charging time data 84 may include the time of the day when the user typically plugs-in to charge the electrified vehicle 10. The charging time data 84 may include information such as the specific time of day for each day of the week that the charge coupler 28 of the charge cord assembly 26 is typically plugged into the charge port assembly 32 for charging, and each typical time for each day of the week can be learned and recorded for helping predict future charging events.

In yet another embodiment, the learned charging habits of the user may be based on battery charge level data 86 that may be received as yet another input to the control module 52. The battery charge level data 86 may include information concerning the specific state of charge (SOC) of the traction battery pack 12 each time the user plugs-in to charge the electrified vehicle 10. For example, the user may only charge when the SOC of the traction battery pack 12 is below a certain level, and thus this type of charge level information may be learned and recorded for helping predict future charging events.

Charging events typically occur following ignition-off conditions of the electrified vehicle 10. The control module 52 may thus additionally predict when the charging event is likely to occur by monitoring the ignition status of the electrified vehicle 10. In this regard, the control module 52 may be further configured to receive a vehicle shutdown signal 88 from an ignition system of the electrified vehicle 10 each time the ignition system is turned off to shut down the electrified vehicle 10.

In response to receiving the vehicle shutdown signal 88 and predicting that a charging event is likely, the control module 52 may take one or more steps to prepare the electrified vehicle 10 for the impending charging event. In an embodiment, the control module 52 may be programmed to automatically communicate a command signal 90 to the contactor system 34 in response to receiving the vehicle shutdown signal 88 and predicting that a charging event is likely. The command signal 90 instructs the contactor system 34 to maintain the one or more sets of contactors 38 in their closed positions for a threshold amount of time following the vehicle shutdown. Maintaining the contactors 38 closed for a relatively short period of time following vehicle shutdown when a charging event is predicted to occur thereafter reduces wear on the contactors 38, decreases the noise, vibration, and harshness associated with ignition-on to ignition-off transitions, and facilitates an improved and more user friendly charging process for the user.

In an embodiment, the threshold amount of time for maintaining the contactors 38 closed may be at least two minutes in length or any other length that is sufficient to allow the user enough time to plug-in the electrified vehicle 10 following a vehicle shutdown. The threshold amount of time is therefore a design specific setting and thus could be calibrated and/or adjusted as desired within the scope of this disclosure.

In another embodiment, when the vehicle shutdown signal 88 has been received and the charging event is predicted as being likely, the control module 52 may communicate a command signal 92 to the charge port assembly 32 of the electrified vehicle 10. The command signal 92 may instruct the charge port assembly 32 to open a charge port door 40 (e.g., via an automatic door opener of the charge port assembly 32), illuminate a charge port lighting module 42, or both (see, e.g., FIG. 3). The electrified vehicle 10 may thus be further prepared for accomplishing the impending charging event.

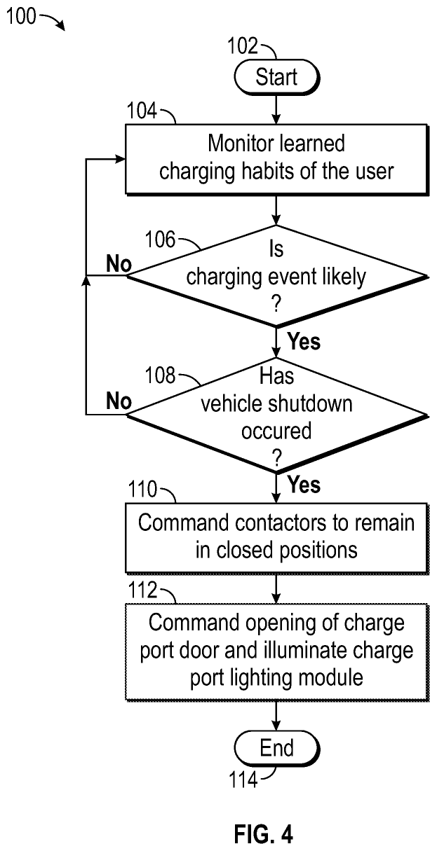

FIG. 4, with continued reference to FIGS. 1-3, schematically illustrates in flow chart form an exemplary method 100 for predicating and preparing the electrified vehicle 10 for charging events. The control module 52 of the vehicle charging system 44 may be configured to employ one or more algorithms adapted to execute at least a portion of the steps of the exemplary method 100. For example, the method 100 may be stored as executable instructions in the memory 80 of the control module 52, and the executable instructions may be embodied within any computer readable medium that can be executed by the processor 78 of the control module 52.

The exemplary method 100 may begin at block 102. At block 104, the method 100 may monitor the learned charging habits of the user of the electrified vehicle 10. The monitoring may include monitoring typical charging locations, charging times, and battery level when charging the electrified vehicle 10, for example.

Next, at block 106, the method 100 may predict whether a charging event is likely to soon occur based on the learned charging habits. If YES, the method 100 may proceed to block 108 by determining whether a vehicle shutdown has occurred. The vehicle shutdown may occur in response to an ignition-off condition, for example.

In response to the charging event prediction and the vehicle shutdown, the method 100 may proceed to block 110 by commanding the contactor system 34 to maintain the one or more sets of contactors 38 in the closed position at block 110. Maintaining the contactors 38 closed for a short time period subsequent to a vehicle shutdown condition reduces the number of open/closed cycles of the contactors 38, thereby significantly increasing the component life expectancy.

Next, at block 112, the method 100 may optionally command the charge port assembly 32 to open the charge port door 40 and/or illuminate the charge port lighting module 42. The method 100 may then end at block 114.

The vehicle charging systems and methods of this disclosure are configured to prepare electrified vehicles for charging when future charging events are predicted as being likely. The electrified vehicle may be prepared for charging by maintaining charging system contactors in a closed position for a threshold amount of time following a vehicle shutdown. Maintaining the contactors closed when charging events are anticipated as being likely may provide numerous advantages, including but not limited to, reducing contactor part wear, decreasing noise, vibration, and harshness, facilitating more satisfying user charging experiences, reducing the number of contactors required to be provided as part of the high voltage bus, etc.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A vehicle charging system, comprising:
a contactor system including at least one contactor; and
a control module programmed to command the at least one contactor to remain in a closed position at a vehicle shutdown when a charging event is predicted as being likely to occur subsequent to the vehicle shutdown.

2. The vehicle charging system as recited in claim 1, wherein the at least one contactor is maintained in the closed position for a threshold amount of time following the vehicle shutdown.

3. The vehicle charging system as recited in claim 2, wherein the threshold amount of time is at least two minutes.

4. The vehicle charging system as recited in claim 1, wherein, in the closed position, the at least one contactor operably connects a traction battery pack to a charge port assembly of the vehicle charging system.

5. The vehicle charging system as recited in claim 1, wherein the control module is further programmed to command a charge port assembly to perform a function when the charging event is predicted as being likely to occur subsequent to the vehicle shutdown.

6. The vehicle charging system as recited in claim 5, wherein the function includes opening a charge port door of the charge port assembly.

7. The vehicle charging system as recited in claim 5, wherein the function includes illuminating a charge port lighting module of the charge port assembly.

8. The vehicle charging system as recited in claim 1, wherein the control module is programmed to predict that the charging event is likely to occur based on learned charging habits of a user of the vehicle charging system.

9. The vehicle charging system as recited in claim 8, wherein the learned charging habits are inferred based on charging location data.

10. The vehicle charging system as recited in claim 8, wherein the learned charging habits are inferred based on charging time data.

11. The vehicle charging system as recited in claim 8, wherein the learned charging habits are inferred based on battery charge level data.

12. The vehicle charging system as recited in claim 1, wherein the control module is programmed to infer the vehicle shutdown based on an ignition-off condition.

13. A method, comprising:
predicting, via a control module of a vehicle charging system, when a charging event is likely to occur; and
commanding a contactor of the vehicle charging system to remain closed at a vehicle shutdown in response to the predicting.

14. The method as recited in claim 13, wherein the predicting includes monitoring a learned charging habit of a user of the vehicle charging system.

15. The method as recited in claim 14, wherein the monitoring includes monitoring charging location data, charging time data, and/or battery charge level data.

16. The method as recited in claim 13, comprising:
commanding a charge port door of a charge port assembly of the vehicle charging system to move to an open position in response to the predicting.

17. The method as recited in claim 13, comprising:
commanding a charge port lighting module of a charge port assembly of the vehicle charging system to illuminate in response to the predicting.

18. The method as recited in claim 13, wherein the commanding includes commanding the contactor to remain closed for a threshold amount of time following the vehicle shutdown.

19. The method as recited in claim 18, wherein the threshold amount of time is at least two minutes.

20. The method as recited in claim 13, wherein the contactor operably connects a traction battery pack to a charge port assembly of the vehicle charging system when closed.
